(19) United States
(12) Patent Application Publication
(10) Pub. No.: US 2004/0108997 A1
(43) Pub. Date: Jun. 10, 2004

(54) Personal digital assistant

(76) Inventor: Huang-Lin Lee, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/379,101

(22) Filed: Mar. 4, 2003

(30) Foreign Application Priority Data
Dec. 10, 2002 (TW) 91135707

(51) Int. Cl. G09G 5/00

(52) U.S. Cl. 345/179

(57) ABSTRACT

A personal digital assistant (PDA). The personal digital assistant (PDA) includes a main body and a PDA stylus. The main body has a channel and a contact switch disposed therein. In particular, the PDA is turned on when the PDA stylus is inserted into the channel and contacts the contact switch, and the PDA is turned off when the PDA stylus is withdrawn from the channel and separates from the contact switch.

### BACKGROUND OF THE INVENTION

1. Field of the Invention

This invention relates to a personal digital assistant (PDA). In particular, it relates to a PDA having a contact switch enabling control of the PDA's power with a PDA stylus.

2. Description of the Related Art

With the variety of portable electronic products, PDA applications have become more and more popular. Since the PDA is small and easy to carry, it is convenient for users when traveling.

Referring to FIG. 1, generally, the conventional PDA 1 has a power button 10. Users can turn the PDA 1 on or off by pushing the power button 10. Moreover, the conventional PDA 1 has attached a PDA stylus (not shown) to use on the touch panel 11. The PDA stylus can be stored inside or apart from the PDA 1 as an accessory.

### SUMMARY OF THE INVENTION

An object of the invention is to provide a personal digital assistant (PDA) having a contact switch enabling control of the PDA's power with a PDA stylus.

The personal digital assistant (PDA) comprises a main body and a PDA stylus. The main body has a channel and a contact switch disposed therein. In particular, the PDA is turned on when the PDA stylus is inserted into the channel and contacts the contact switch, and the PDA is turned off when the PDA stylus is withdrawn from the channel and separates from the contact switch.

The personal digital assistant (PDA) in accordance with the present invention needs no power button such that users can easily turn the PDA on and off by simply inserting and withdrawing the PDA stylus into and out of the channel with no additional operations. Moreover, the personal digital assistant (PDA) in accordance with the present invention not only reduces the complexity of production but also saves more space and operating time due to the absence of the power button.

### BRIEF DESCRIPTION OF THE DRAWINGS

The present invention can be more fully understood by reading the subsequent detailed description and examples with references made to the accompanying drawings, wherein:

FIG. 1 is a perspective diagram of a conventional PDA;

FIG. 2 is a perspective diagram of the PDA in accordance with the present invention;

FIG. 3 is a perspective diagram of the PDA in accordance with the first embodiment of the present invention;

FIG. 4 is a perspective diagram of a the PDA in accordance with the second embodiment of the present invention;

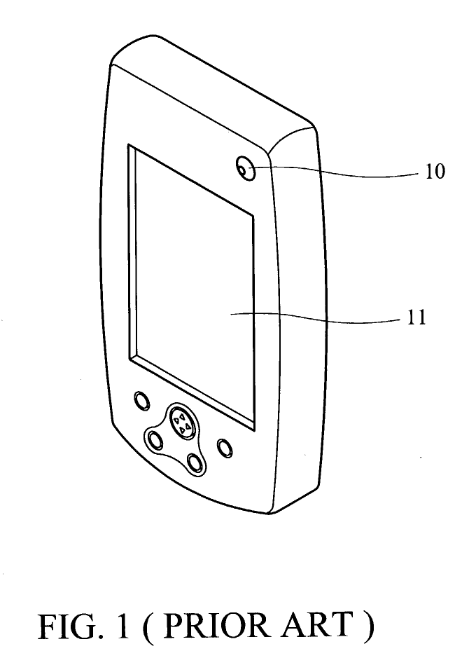

### DETAILED DESCRIPTION OF THE INVENTION

### FIRST EMBODIMENT

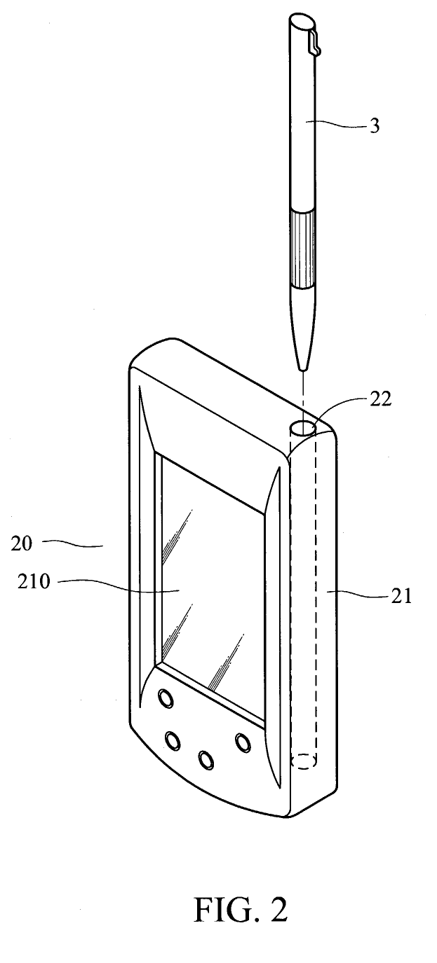

FIG. 2 is a perspective diagram of the PDA in accordance with the present invention. The PDA 2 comprises a main body 20 and a PDA stylus 3. The main body 20 includes a case 21, a display panel 210 and a channel 22. The display panel 210 is seated in the front bezel of the PDA 2 and the channel 22 is defined inside the main body 20 such that the PDA stylus 3 can be stored therein.

As mentioned above, users can easily withdraw the PDA stylus 3 from the channel 22 to operate the PDA 2. When the PDA 2 is not in use, the PDA stylus 3 can be inserted and stored inside the channel 22 safely. Thus, it is convenient for users to operate or store the PDA stylus 3.

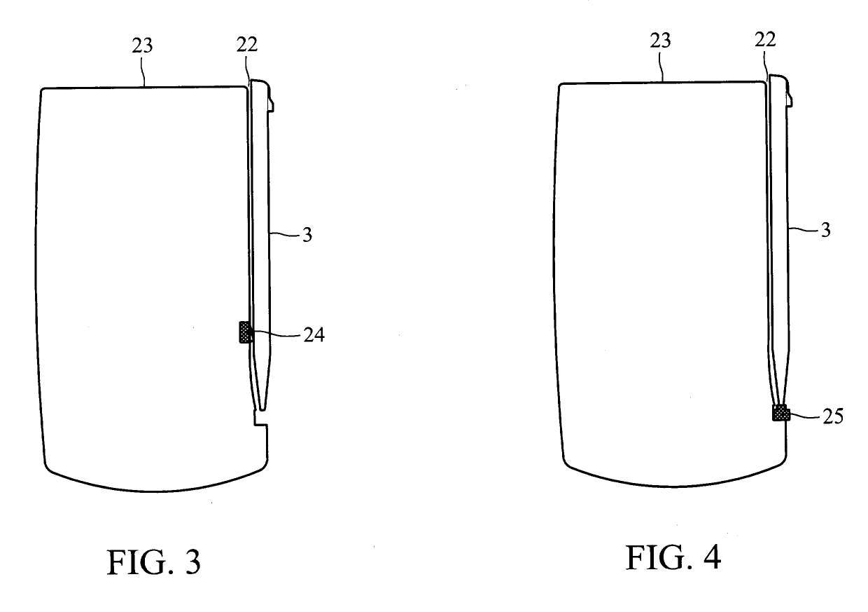

FIG. 3 is a perspective diagram of the PDA in accordance with the first embodiment of the present invention. Additionally, as shown in FIG. 3, a printed circuit board 23 is disposed inside the main body 20 of the PDA 2. The channel 22 is defined and adjoined by one side of the printed circuit board 23. In particular, the contact switch 24 is disposed on the inner surface of the channel 22 and connected to both the printed circuit board 23 and the power supply (not shown) of the PDA 2. The contact switch is preferred a limit switch. Thus, the power supply of the PDA 2 can be switched on or off with the switch 24.

Referring to FIG. 3, with the switch 24 disposed on the inner surface of the channel 22, the side of the PDA stylus 3 contacts the switch 24 when inserted into the channel 22. Once the switch 24 is contacted, the power supply of the PDA 2 is turned off.

When the PDA stylus 3 is withdrawn and the switch 24 separates from the PDA stylus 3, the switch 24 loses contact and the power supply of the PDA 2 is turned on immediately.

As mentioned in the first embodiment, it is convenient that the personal digital assistant (PDA) can be turned on and off by simply inserting and withdrawing the PDA stylus into and out of the channel with no additional operations. Moreover, the invention also reduces the complexity of production and saves more space and operating time due to the absence of a power button.

### SECOND EMBODIMENT

FIG. 4 is a perspective diagram of a PDA in accordance with the second embodiment of the present invention. As shown in FIG. 4, a printed circuit board 23 connected to a tactile switch 25 is disposed inside the main body 20 of the PDA 2, and the channel 22 is defined and adjoined by one side of the printed circuit board 2. In particular, the tactile switch 25 is located at the bottom of the channel 22 and connected to the printed circuit board 23 and the power supply (not shown) of the PDA 2. Thus, the power supply of the PDA 2 can be switched on or off with the tactile switch 25.

Referring to FIG. 4, with the tactile switch 25 located at the bottom of the channel 22, the tip of the PDA stylus 3 contacts the tactile switch 25 when inserted into the channel 22. Once the tactile switch 25 is contacted, the power supply of the PDA 2 is turned off.

On the contrary, when the PDA stylus 3 is withdrawn and the tip separates from the tactile switch 25, the tactile switch 25 loses contact and the power supply of the PDA 2 is turned on immediately.

In particular, the personal digital assistant (PDA) in accordance with the present invention with the switch 24 in first embodiment and the tactile switch 25 in the second embodiment can use any contact switch.

In summary, the personal digital assistant (PDA) in accordance with the present invention needs no power button such that users can easily turn the PDA on and off by simply inserting and withdrawing the PDA stylus into and out of the channel with no additional operations. Moreover, the personal digital assistant (PDA) can reduce the complexity of production and save more space and operating time with no need for a power button.

When the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A personal digital assistant (PDA), comprising:
a PDA stylus;
a main body, having a channel; and
a contact switch, disposed in the channel;
wherein the PDA is turned on or off by controlling the PDA stylus touching the contact switch.

2. The personal digital assistant (PDA) as claimed in claim 1, wherein the main body further comprises a printed circuit board (PCB) connected to the contact switch.

3. The personal digital assistant (PDA) as claimed in claim 1, wherein the PDA stylus has a side, the contact switch is set on the inner sidewall of the channel, and the PDA is turned on or off by controlling the side of the PDA stylus touching the contact switch.

4. The personal digital assistant (PDA) as claimed in claim 1, wherein the PDA stylus has a tip, the contact switch is set on the bottom of the channel, and the PDA is turned on or off by controlling the tip of the PDA stylus touching the contact switch.

5. The personal digital assistant (PDA) as claimed in claim 1, wherein the contact switch is a limit switch.

6. The personal digital assistant (PDA) as claimed in claim 1, wherein the contact switch is a tactile switch.

7. A personal digital assistant (PDA), comprising:
a PDA stylus;
a main body, having a channel; and
a contact switch, disposed at the channel;
wherein the PDA is turned on when the PDA stylus is inserted into the channel, and the PDA is turned off when the PDA stylus is released from the channel.

8. The personal digital assistant (PDA) as claimed in claim 7, the main body further having a printed circuit board (PCB) connected to the contact switch.

9. The personal digital assistant (PDA) as claimed in claim 7, wherein the PDA stylus has a side, the contact switch is set on the inner sidewall of the channel, and the PDA is turned on or off by controlling the side of the PDA stylus touching the contact switch.

10. The personal digital assistant (PDA) as claimed in claim 7, wherein the PDA stylus has a tip, the contact switch is set on the bottom of the channel, and the PDA is turned on or off by controlling the tip of the PDA stylus touching the contact switch.

11. The personal digital assistant (PDA) as claimed in claim 7, wherein the contact switch is a limit switch.

12. The personal digital assistant (PDA) as claimed in claim 7, wherein the contact switch is a tactile switch.
